(19) United States
(12) Patent Application Publication
(10) Pub. No.: US 2026/0161390 A1
(43) Pub. Date: Jun. 11, 2026

(54) Systems and Methods for Automatically Determining Code Lineage

(71) Applicant: Snyk Limited, London (GB)

(72) Inventors: Natasha Chernyavsky, Tel Aviv (IL); Yaron Dinur, Tel Aviv (IL); David Gonoradsky, Tel Aviv (IL); Lior Govrin, Tel Aviv (IL); Oren Levy, Givatayim (IL); Ran Nozik, Tel Aviv (IL)

(21) Appl. No.: 19/410,919

(22) Filed: Dec. 5, 2025

Related U.S. Application Data
(60) Provisional application No. 63/728,347, filed on Dec. 5, 2024.

(51) Int. Cl. G06F 8/75; G06F 8/71

(52) U.S. Cl. CPC G06F 8/75; G06F 8/71

(57) ABSTRACT

Embodiments automatically determine code lineage. One such embodiment determines at least one component fingerprint associated with a software component and determines at least one code fingerprint associated with a codebase. In turn, correspondence between the determined at least one component fingerprint and the determined at least one code fingerprint is evaluated to determine code lineage of the software component.

### RELATED APPLICATION

This application claims the benefit of U.S. Provisional Application No. 63/728,347, filed on Dec. 5, 2024. The entire teachings of the above application are incorporated herein by reference.

### BACKGROUND

A code to cloud security approach may include, e.g., identifying security issues in code and preventing the security issues from reaching the cloud, and identifying security issues in cloud deployments and tracing them back to the code.

### SUMMARY

Conventional approaches lack the ability to automatically correlate runtime signals with source code, e.g., source code that includes security issues. Instead, traditional approaches typically require a tedious process of manually associating source code and cloud workloads. Embodiments address the foregoing and other limitations of existing methods and systems.

An example embodiment is directed to a computer-implemented method of automatically determining code lineage. The method begins by determining (i) at least one component fingerprint associated with a software component (e.g., one or more programming scripts and/or one or more container images, etc.) and (ii) at least one code fingerprint associated with a codebase. In turn, correspondence between the determined at least one component fingerprint and the determined at least one code fingerprint is evaluated to determine code lineage of the software component.

In an example embodiment, the software component may include a file hierarchy. According to an aspect, the file hierarchy may consist of multiple file hierarchies, e.g., for a container image that includes multiple file hierarchies. Similarly, the codebase may include a set of file hierarchies (e.g., a set of sub-trees of a code repository). Determining the at least one component fingerprint may include generating first segment data (e.g., generating/identifying a first set of unique segments) from the file hierarchy. The at least one component fingerprint may include the first segment data. Determining the at least one code fingerprint may include generating second segment data (e.g., generating/identifying a second set of unique segments) from the set of file hierarchies. The at least one code fingerprint may include the second segment data. Evaluating the correspondence between the determined at least one component fingerprint and the determined at least one code fingerprint may include comparing the generated first segment data and the generated second segment data. In one such embodiment, the evaluating may further include: (1) based on a result of comparing the generated first segment data and the generated second segment data, generating a set of candidate file hierarchies from the set of file hierarchies and (2) comparing the file hierarchy and the generated set of candidate file hierarchies to determine the code lineage. According to another such embodiment, the generated first segment data and the generated second segment data may include at least one of: (i) filename data, (ii) directory name data, and (iii) optional segment frequency data. Further, in yet another such embodiment, comparing the generated first segment data and the generated second segment data may be based on a threshold. According to one such embodiment, the threshold may be 80%. In another such embodiment, the threshold may be configurable, e.g., via user input.

According to an example embodiment, the software component may include a container image. Determining the at least one component fingerprint may include extracting at least one container image layer (e.g., multiple container image layers) from the container image. The at least one component fingerprint may include the at least one container image layer. Determining the at least one code fingerprint may include extracting at least one build command (e.g., at least one Docker command) from the codebase. The at least one code fingerprint may include the at least one build command. Evaluating the correspondence between the determined at least one component fingerprint and the determined at least one code fingerprint may include comparing the extracted at least one container image layer and the extracted at least one build command to determine the code lineage. In one such embodiment, the method may further include normalizing the extracted at least one container image layer.

In an example embodiment, the software component may include multiple software components. The method may further include: (1) selecting a given software component of the multiple software components based on the determined code lineage and at least one runtime property of the given software component and (2) analyzing the selected software component. According to one such embodiment, a given runtime property of the at least one runtime property may indicate that the selected software component is: deployed to a production environment, not in use, deployed to a secure environment, publicly accessible, or loaded in an execution environment.

According to an example embodiment, the codebase may include multiple errors. The method may further include: (1) selecting a given error of the multiple errors based on the determined code lineage and (2) rectifying the selected given error.

In an example embodiment, the codebase may include multiple code repositories. The determined code lineage may indicate correspondence between the software component and a code repository of the multiple code repositories.

Another example embodiment is directed to a computer-based system for automatically determining code lineage. The system includes a processor and a memory with computer code instructions stored thereon. The processor and the memory, with the computer code instructions, are configured to cause the system to implement any embodiments or combination of embodiments described herein.

Yet another embodiment is directed to a computer program product for automatically determining code lineage. The computer program product includes a non-transitory computer-readable medium with computer code instructions stored thereon. The computer code instructions are configured, when executed by a processor, to cause an apparatus associated with the processor to implement any embodiments or combination of embodiments described herein.

It is noted that embodiments of the method, system, and computer program product may be configured to implement any embodiments or combination of embodiments described herein.

### BRIEF DESCRIPTION OF THE DRAWINGS

The foregoing will be apparent from the following more particular description of example embodiments, as illustrated in the accompanying drawings in which like reference characters refer to the same parts throughout the different views. The drawings are not necessarily to scale, emphasis instead being placed upon illustrating embodiments.

FIG. 1 is an example user interface according to an embodiment.

FIG. 2 is a flowchart of a method of automatically determining code lineage according to an example embodiment.

FIG. 3 is a schematic view of a computer network in which embodiments may be implemented.

FIG. 4 is a block diagram illustrating an example embodiment of a computer node in the computer network of FIG. 3.

### DETAILED DESCRIPTION

A description of example embodiments follows.

### INTRODUCTION

In an embodiment, leveraging runtime signals can help reduce or prevent the unwanted phenomenon of “alert fatigue” that may arise from issues (e.g., coding errors, security vulnerabilities, etc.) in source code detected by software composition analysis (SCA) and/or Static Application Security Testing (SAST) tools. In real-world settings, software developers and application security (AppSec) professionals are often flooded with hundreds or thousands of issues, but lack an effective way of prioritizing the multitude of issues. For instance, an issue may be detected that relates to a critical vulnerability in a particular software package. It may also be determined, however, that the package is not deployed to production, is not used, or runs in an unexploitable environment. The foregoing are examples of runtime signals that can be used to significantly reduce issue load—and thus alert fatigue—by assigning a lower priority to issues detected in software packages having such runtime signals. However, correlating runtime signals of software packages with the underlying source code (from which SCA and SAST issues originate) cannot be accomplished automatically with existing approaches or in many cases requires a tedious process of manually associating source code and cloud workloads. For example, a tag, identifier, or other metadata may be added to source code during a continuous integration and continuous delivery (CI/CD) process. The tag may then be propagated through the process to an eventual production image. In turn, the tag may be matched with certainty between the image and the code. However, such an approach of including metadata in a CI/CD process must be carried out for each CI/CD pipeline. This is a burdensome and manual undertaking that does not scale when attempted with a voluminous number of source code repositories. Moreover, many organizations employ a decentralized CI/CD process, which makes the metadata-based approach prohibitively complex. Embodiments solve these problems, among others, by automatically determining code lineage.

### Detecting Risky Code and Potential Security Issues

Detecting risky code during a software development process may facilitate preventing or mitigating security vulnerabilities when the software is later deployed to a production environment. SCA may play a role in identifying risky code by analyzing open-source components for known vulnerabilities. For example, SCA may be used to examine dependencies on open-source components in code repositories and notify developers of any risks associated with those components.

SAST and Dynamic Application Security Testing (DAST) are complementary approaches for detecting security vulnerabilities. SAST may be used to examine source code of a program for potential security vulnerabilities without running the program, thereby highlighting issues at the coding stage. DAST may be used to analyze a software application in its running state. For example, DAST may include simulating attacks to find vulnerabilities that appear only during operation of an application.

### Tracing Cloud Security Issues to Source Code

Tracing security issues back to their origins in source code may facilitate rapidly remediating issues. For non-limiting example, security issues can occur in cloud workloads such as virtual machines, containers, and serverless functions. Security issues can also occur in cloud services and configurations, as well as in web applications and application programming interfaces (APIs) hosted within cloud environments.

A code to cloud approach may include using one or more tools to detect cloud security issues and trace them back to the underlying source code. Code to cloud approaches identify code lineage and use the code lineage to perform the aforementioned tracing.

### Example Benefits of Code to Cloud

Code to cloud, e.g., code lineage, can readily integrate with a software delivery process that uses a development, security, and operations (DevSecOps) approach because code to cloud emphasizes security throughout an entire software delivery pipeline. By detecting and addressing potential security issues at the earliest possible stage, code to cloud can significantly enhance security of a final software product.

In addition, the complexity of cloud environments continues to increase. Given the vast number of services, configurations, and security settings currently available in cloud platforms, overseeing and securing these environments has become a significant challenge. A code to cloud approach can help to address the complexity of cloud environments by providing a standardized process for identifying security issues at various stages, e.g., all stages, of a cloud development process, e.g., a cloud native development process. For example, security issues may be identified and resolved in early development stages. Alternatively, security issues may be detected in production systems and traced back to the underlying source code for rapid remediation.

Code to cloud can also enhance a CI/CD process by ensuring that code is secure, reliable, and ready for deployment at all times. By providing automated testing and security scanning, which may be integrated into a CI/CD pipeline, a code to cloud approach can ensure that any software artifact passing through the pipeline is secure.

In addition, code to cloud can help to ensure compliance with regulatory requirements for software by incorporating security checks and controls into a software delivery process. Through automated testing and security scanning, a code to cloud approach can identify and resolve any compliance issues before software is deployed. Such an approach can also provide an audit trail that may be used to prove the existence and effectiveness of security controls.

Moreover, new cyberthreats continue to emerge. As cloud environments, e.g., native cloud environments, rapidly evolve, cybercriminals and other malicious actors are constantly developing techniques and tactics to exploit nascent vulnerabilities. Organizations accordingly stress the importance of having quick response capabilities to protect their systems and data. Code to cloud can help to address the rapid evolution of cyberthreats by providing a continuous, automated process for detecting and resolving security vulnerabilities in code and production systems. As new threat intelligence is obtained, it can immediately be used to test code in development and identify weaknesses in production systems.

### Overview of Example Embodiments

An example embodiment can perform deep analysis of software components, e.g., cloud workloads and container images. For instance, an example embodiment can extract unique characteristics that remain invariant from source code all the way to production and use the characteristics to establish code lineage, e.g., code to cloud correlation. Another example embodiment can establish code lineage automatically and reliably for rich applications where such invariants are available. Described hereinbelow are two example methods for generating automated code lineage.

Some example embodiments may establish correlation using a file and/or class hierarchy. An example embodiment may leverage the insight that a hierarchical structure of source code remains similar in runtime for interpreted languages (e.g., Node.js®, Python®, Ruby, etc.) and runtime-based languages (e.g., Java™). For instance, Python and JavaScript® source code files are typically copied as-is during a build process (except for, e.g., test files or where minimization, etc., is performed). This verbatim copying preserves a directory structure as it appears in the source code. In Java, an application Java archive (JAR) file contains class files (.class files) compiled from original source code files (.java files). The JAR file keeps the same directory structure as well. With C#/.NET, class names may similarly be identified from a dynamic-link library (DLL). An example embodiment can capture such information at runtime and compare it to a list of source code files from, e.g., source control/code management (SCM) repositories. For instance, an example embodiment can scan running containers or container images file systems to capture runtime information. Other known interpreted and runtime-based languages are also suitable.

Other example embodiments may establish correlation using container image layers. An example embodiment can extract a “history” metadata object or item, which may contain a history of layers used to build an image. In an implementation, container images in, e.g., Kubernetes®, may be analyzed; for instance, the images may be stored in a container image store. According to an aspect, container image registries, e.g., Docker Hub®, Amazon® Elastic Container Registry (ECR), etc., may be analyzed. Other known container orchestration systems and container image registries are also suitable. In an embodiment, container image layers can be normalized and compared to actual build commands appearing in, e.g., Dockerfile files of a Docker® container service provider, to establish a correlation. Other known container service providers are also suitable. By employing an approach that establishes correlation using container image layers, an example embodiment may operate in a manner that is not language-specific and only utilizes a command used to build an image.

### Example File Tree/Hierarchy Correlation

Described hereinbelow is an example implementation of automatically determining code lineage based on file tree/hierarchy correlation for applications developed using interpreted programming languages, e.g., Node.js.

An example embodiment may correlate (i) a file tree/hierarchy that is observed in runtime without repository context and (ii) a corresponding file structure in a source code repository that is observed in static code analysis.

Another example embodiment may identify the origin of files running in production by linking them back to a known codebase from a repository.

Embodiments can overcome technical challenges arising from evidence or input comparisons. For example, file trees or hierarchies may be observed from different sources, such as runtime environments (e.g., container filesystems) and static repositories. It may thus be necessary to efficiently match and correlate the file trees. However, a strict or exact comparison of file trees or path segments (e.g., directory names or filenames) may be infeasible because of slight variations caused by, e.g., differences in file structure and minor filename discrepancies or mismatches. Such mismatches may often occur because source code frequently changes, while the source code is being compared to images which are immutable. An example embodiment may thus employ a segment list matching approach. Instead of strictly or exactly comparing entire file trees or hierarchies, an example embodiment may compare a list of path segments. This allows for a flexible, scalable, and efficient (e.g., query-efficient or Structured Query Language (SQL) efficient) means of approximating matches between evidence or input coming from different sources, e.g., runtime environments and source code repositories.

Embodiments can also overcome technical challenges arising from query complexity. For example, loading all records from a database and comparing them in-memory to calculate an exact match percentage may be inefficient and resource-intensive. An example embodiment can minimize the number of comparisons by filtering results directly through database queries (e.g., SQL queries) that provide room for mismatches while still focusing on high-probability matches. The design of an example embodiment can also introduce tolerance in segment list mismatches of, e.g., 80%. This may allow for reasonable variations between runtime and source code repository file structures.

For instance, using a threshold such as 80% may significantly reduce the number of potentially matching code repositories (e.g., to a single-digit number), while leaving an adequate margin of error, e.g., due to code changes that may create a delta or divergence between a code repository and a currently deployed container image. The potential matches meeting the threshold cutoff may then be used as candidates for a full comparison.

Embodiments can overcome technical challenges arising from imbalances in frequency of file tree/hierarchy reporting or updates. Runtime environments may update file structures more frequently than scans of source code repositories. For example, a container image may be built every 10 minutes. Conversely, in some circumstances, source code may change more frequently than a runtime environment because not all source code changes may be immediately deployed to runtime. These differing update frequencies may introduce a risk of distorting comparisons if the more frequent reports dominate the data. An example embodiment may address this challenge by using segment matching, optionally with a threshold (e.g., 80%), as described herein.

### Example Configurations and Code for Implementing Embodiments

Described hereinbelow are example configurations and code for implementing embodiments. These include example database schemas, data types, data formats, and database queries.

### Example Database Schemas

In an embodiment, different database tables may be used to store different types of evidence or data used to automatically determine code lineage. For instance, runtime information about software components may be stored in a database table named image_evidence that has the following example table columns:

id,
group_id,
org_id,
image_id,
data_source −> provider
evidence_type,
evidence_value,
sub_source −> source / origin
created_at,
updated_at

In an implementation, the id field may be a database identifier. The group_id and org_id fields may be identifiers that are used internally by a security platform to implement customer hierarchies. The image_id field may be an identifier of a container image. The data_source->provider field may be used to describe a source from which data is collected, e.g., a Kubernetes environment or via container registry integration. The sub_source->source/origin field may be used to store a more specific description of a data source, e.g., an Azure® container registry.

According to an aspect, the example image_evidence table may be used to store evidence or data of example types runtimeFileHierarchy and, optionally, runtimePathSegment Frequencies. In an implementation, a value of the evidence_type field for a given row in the image_evidence table may indicate which of the two example data types is stored in that row. According to an embodiment, the evidence_value table column may be a JSONB field, i.e., to store JavaScript Object Notation (JSON) data in a binary representation. In an aspect, when the value of the evidence_type field is runtimeFileHierarchy, the corresponding evidence_value field will contain data in an example fileList format (described hereinbelow). When the value of the evidence_type field is the optional type runtimePathSegmentFrequencies, the corresponding evidence_value field will contain data in an optional segment Frequencies format (described hereinbelow).

In an embodiment, source code information about software components may be stored in a database table named source_code_evidence that has the following example table columns:

id,
group_id,
org_id,
repo_url,
data_source −> provider
evidence_type,
evidence_value,
sub_source −> source / origin
created_at,
updated_at

In an implementation, the fields of the example source_code_evidence table may similar to those of the example image_evidence table described hereinabove, except that instead of an image_id field, the source_code_evidence table may include a repo_url field that is used to store an identifier (e.g., a link such as a uniform resource locator (URL)) for a source code repository.

According to an aspect, the example source_code_evidence table may be used to store evidence or data of example types repoFileHierarchy and, optionally, repoPathSegmentFrequencies. In an implementation, a value of the evidence_type field for a given row may indicate which of the two example data types is stored in that row. According to an embodiment, the evidence_value table column may be a JSONB field. In an aspect, when the value of the evidence_type field is repoFileHierarchy, the corresponding evidence_value field will contain data in an example fileList format. When the value of the evidence_type field is the optional type repoPathSegmentFrequencies, the corresponding evidence_value field will contain data in the optional segment Frequencies format.

### Example Data Formats

Below is a non-limiting example of data in the optional segment Frequencies format, which format may be used with optional data types such as runtimePathSegment Frequencies and repoPathSegmentFrequencies:

```
{
  “segmentFrequencies”:
  {
    “src”: 10,
    “components”: 2,
    “utils”: 2,
    “hooks”: 2,
    “services”: 2,
    “tests”: 4,
    “Navbar”: 1,
    “Footer”: 1,
    “logger”: 2,
    “validator”: 2,
    “useLocalStorage”: 1,
    “apiService”: 1
  }
}
```

Below is a non-limiting example of data in the fileList format, which format may be used with data types such as runtimeFileHierarchy and repoFileHierarchy:

```
{
  “fileList”:
  [
    “src/components/Navbar.js”,
    “src/components/Footer.js”,
    “src/utils/logger.js”,
    “src/utils/validator.js”,
    “src/hooks/useLocalStorage.js”,
    “src/services/apiService.js”,
    “src/tests/logger.test.js”,
    “src/tests/validator.test.js”,
    “src/tests/hooks.test.js”,
    “src/tests/services.test.js”
  ],
}
```

### Example Queries for Counterpart Data

In an implementation, when new evidence or data is obtained from, e.g., a runtime environment or source code, and saved, a query may be used to retrieve the most similar data of the “opposite” or counterpart type. For instance, if runtime data is stored, a query may be used to fetch source code data where a percentage of matching segments is greater than or equal to a threshold, e.g., 80%. If source code data is stored instead, a query may likewise be used to retrieve the most similar runtime data.

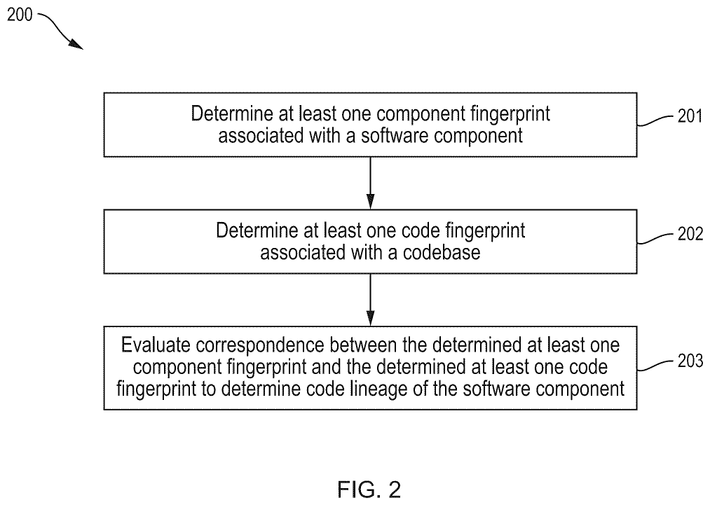

According to an aspect, queries described herein may be used with the example method 200 (described hereinbelow with respect to FIG. 2). For example, the queries may be used to retrieve information relating to the file hierarchy, the set of file hierarchies, the first segment data, and/or the second segment data, which information may be stored in database tables such as the example image_evidence and source_code_evidence tables described hereinabove.

Below is an example query in the SQL database query language to correlate runtime data, e.g., container image data, with source code data; other known query languages are also suitable.

| | |
|---|---|
| 1 | -- Correlate image evidence |
| 2 | WITH image_segments AS ( |
| 3 | SELECT |
| 4 | KEY AS segment, |
| 5 | value::int AS frequency |
| 6 | FROM |
| 7 | entities.image_evidences, |
| 8 | LATERAL jsonb_each_text(evidence_value −> |
| | ‘segmentFrequencies’) |
| 9 | WHERE |
| 10 | id = $imageEvidenceId |
| 11 | ) |
| 12 | SELECT |
| 13 | * |
| 14 | FROM |
| 15 | entities.source_code_evidences source_code_evidence |
| 16 | WHERE |
| 17 | group_id = $groupId |
| 18 | AND evidence_type = ‘pathSegmentFrequencies’ |
| 19 | AND( |
| 20 | SELECT |
| 21 | COUNT(*) |
| 22 | FROM LATERAL |
| | jsonb_each_text(source_code_evidence.evidence_value −> |
| | ‘segmentFrequencies’) source_code_segments |
| 23 | JOIN image_segments ON image_segments.segment = |
| | source_code_segments.key |
| 24 | ) >= ( |
| 25 | SELECT |
| 26 | 0.80 * COUNT(*) |
| 27 | FROM |
| 28 | image_segments); |

As shown in the above example query, in an embodiment, runtime data may first be retrieved in the example segment Frequencies format based on an imageEvidenceId identifier for desired runtime data (e.g., container image data). In turn, based on a groupId identifier for a desired source code data group, source code data may be retrieved where a percentage of segments matching the retrieved runtime data is greater than or equal to 80%.

Below is an example query in the SQL database query language to correlate source code data with runtime data; other known query languages are also suitable.

| | |
|---|---|
| 1 | -- Correlate source code evidence |
| 2 | WITH source_code_segments AS ( |
| 3 | SELECT |
| 4 | KEY AS segment, |
| 5 | value::int AS frequency |
| 6 | FROM |
| 7 | entities.source_code_evidences, |
| 8 | LATERAL jsonb_each_text(evidence_value −> |
| | ‘segmentFrequencies’) |
| 9 | WHERE |
| 10 | id = $1 |
| 11 | ) |
| 12 | SELECT |
| 13 | * |
| 14 | FROM |
| 15 | entities.image_evidences image_evidence |
| 16 | WHERE |
| 17 | group_id = $2 |
| 18 | AND evidence_type = ‘pathSegmentFrequencies’ |
| 19 | AND( |
| 20 | SELECT |
| 21 | COUNT(*) |
| 22 | FROM LATERAL |
| | jsonb_each_text(image_evidence.evidence_value −> |
| | ‘segmentFrequencies’) image_segments |
| 23 | JOIN source_code_segments ON |
| | source_code_segments.segment = image_segments.key |
| 24 | ) >= ( |
| 25 | SELECT |
| 26 | 0.80 * COUNT(*) |
| 27 | FROM |
| 28 | LATERAL |
| | jsonb_each_text(image_evidence.evidence_value −> |
| | ‘segmentFrequencies’) image_segments) |

As shown in the above example query, in an embodiment, source code data may first be retrieved in the example segment Frequencies format based on an identifier (e.g., $1) for desired source code data. In turn, based on an identifier (e.g., $2) for a desired runtime data group, runtime data may be retrieved where a percentage of segments matching the retrieved source code data is greater than or equal to 80%.

The distinction between the above queries—i.e., one query correlates runtime data to source code data, whereas the other query correlates source code data to runtime data—can be used to confirm that an example correlation function is symmetric. In an aspect, for both example queries above, a match percentage may be calculated based on runtime (e.g., image) segments found in source code segments. One reason to use the same approach in both query types may be that a runtime file hierarchy includes sub-trees. This may occur for example when a source code repository includes multiple projects.

According to an embodiment, the different types of correlations may be required to preserve symmetry of an example correlation function. In an implementation, for both example query types, a match percentage may be calculated based on runtime (e.g., image) segments found in source code segments. One reason for such an approach is that an example embodiment may observe file hierarchy sub-trees in runtime data in a scenario where a source code repository includes multiple projects.

### Example Programmatic Comparison

After retrieving potentially matching data (such as by using one of the example queries described above), an example embodiment may perform a more thorough programmatic comparison by iterating through data in the example fileList format stored in the evidence_value field of the retrieved table rows (i.e., where the evidence_type field is runtimeFileHierarchy or repoFileHierarchy) to compute exact similarity. In an aspect, when performing such a programmatic comparison, more complex comparison logic or techniques may be applied. For instance, an example embodiment may handle or recognize file name/type differences (e.g., TypeScript (.ts) versus JavaScript (.js)), file renaming, and different file/directory structures, among other examples.

### Example User Interface

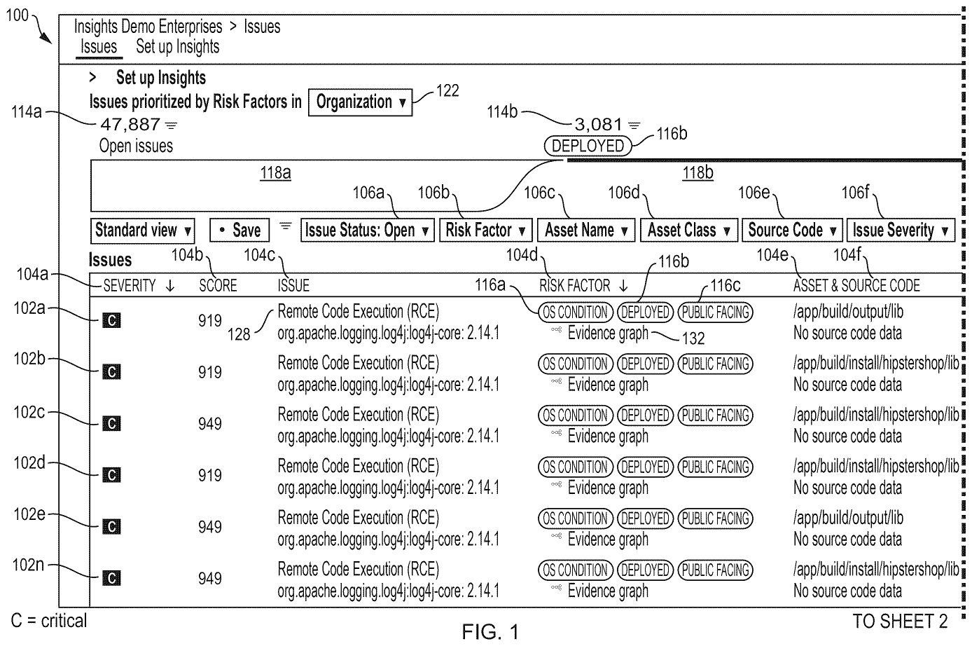

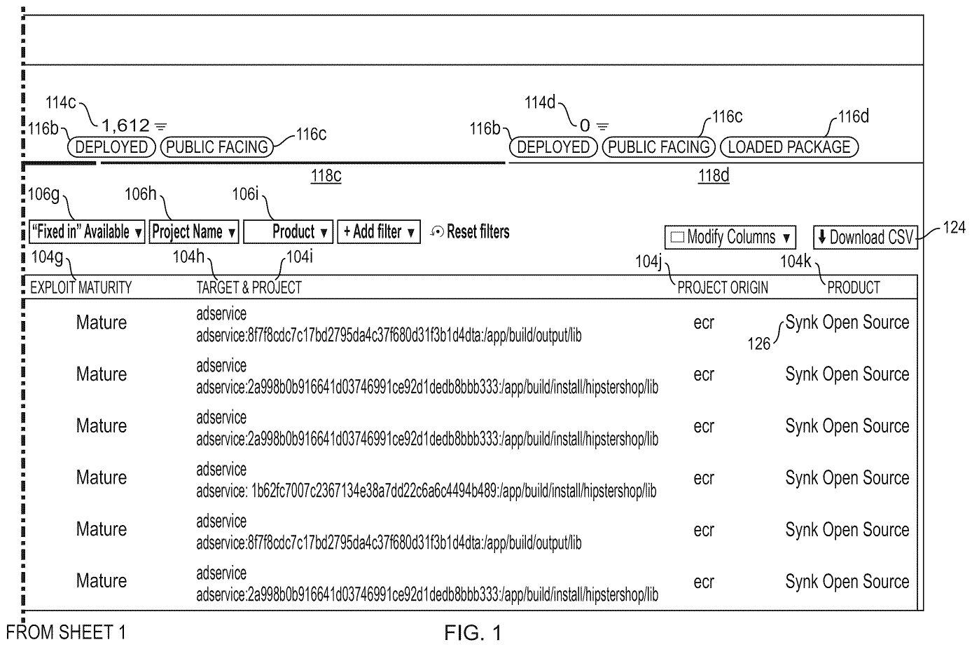

FIG. 1 is an example user interface (UI) 100 according to an embodiment. As shown in FIG. 1, the UI 100 displays a list of issues 102a-102n having properties 104a-104k. The displayed issues 102a-102n may result from the settings of example filters 106a-106i, example filters 114a-114d, and/or example filter 122. The filters 114a-114d may correspond to one or more runtime properties or risk factors 116a-116d. UI element 108 may be used to add a filter to the set of filters 106a-106i, while UI element 112 may be used to reset the filters 106a-106i to their initial settings. UI element 124 may be used to export or download information about the displayed issues 102a-102n in a format, e.g., comma-separated values (CSV), that can be used with other tools and platforms. Other known formats are also suitable.

In an implementation, the UI 100 may be used with the example method 200 (described hereinbelow with respect to FIG. 2). For example, the filter 114d may be used to select software component(s) for analysis with runtime properties of being deployed 116b to a production environment, publicly accessible 116c, and loaded 116d in an execution environment.

In an embodiment, the UI 100 may be provided for users to prioritize and/or triage multiple issues. According to an aspect, prior to interacting with the UI 100, users may onboard their applications or source code repositories (e.g., by integrating the development workflows with a tool such as Snyk® AppRisk provided by Applicant-Assignee Snyk Limited), configure tagging between assets (e.g., to categorize security-related assets like code repositories and build artifacts), and/or configure an interface or bridge (e.g., a Kubernetes connector) to acquire or import runtime data (e.g., container image data).

According to an aspect, one or more of the filters 106a-106i may be shaded with a different color or otherwise displayed in a different manner from the other filters to indicate that the filters have been selected or activated. For example, as shown in FIG. 1, the filter 106a may be selected to display issues (e.g., 102a-102n) having an issue status of “open.” In an implementation, open issues may include detected issues such as open source, code, and container issues.

In an embodiment, each issue 102a-102n may be assigned a severity level 104a of critical (C), high (H), medium (M), or low (L), which may indicate a level of risk as assessed by a security product. According to an aspect, laws, regulations, and/or compliance rules may require or mandate that critical and high severity 104a issues (e.g., 102a-102n) be given priority over medium and low severity 104a issues. However, if a voluminous number of repositories, e.g., 10,000, are onboarded, this may still result in, e.g., hundreds or even thousands, of critical and high severity 104a issues detected by testing systems. The example UI 100 according to an embodiment solves the problem of contending with a vast quantity of issues by providing actionable information and context around those issues.

In an implementation, asset 104e field may indicate a path within a container in which an executable is found. According to an aspect, when an issue 102a-102n relates to source code, source code 104f field may indicate, e.g., a path, a directory name, or a link to a source code directory or repository. Otherwise—for instance when an issue 102a-102n relates to a container image-a message such as “No source code data” may be displayed in the source code 104f field.

According to an embodiment, the filters 114a-114d may be clickable UI elements that allow filtering of the issues 102a-102n. A given filter 114a-114d may correspond to a set of risk factors or conditions. For instance, the filter 114b may correspond to risk factor 116b; the filter 114c may correspond to risk factors 116b and 116c; and the filter 114d may correspond to the risk factors 116b-116d.

In an implementation, one of the filters 114a-114d may be shaded with a different color or otherwise displayed in a different manner from the other filters to indicate that the filter has been selected or activated. For example, as shown in FIG. 1, the filter 114a may be selected to display open issues (e.g., 102a-102n), which may have a count of, e.g., 47,887, issues. In an embodiment, each filter 114a-114d may have a corresponding graphical indicator 118a-118d. The indicators 118a-118d may be used to visualize the number of issues associated with a corresponding filter 114a-114d. For example, the sizes of the indicators 118a-118d may become progressively smaller as each filter 114a-114d is selected in turn. As shown in the example of FIG. 1, this may result in the number of issues being narrowed from 47,887 to 3,081, then to 1,612, and finally to 0. Other known data visualization techniques are also suitable.

According to an aspect, the risk factor 116a may be an operating system (OS) condition indicating that an issue applies to a given OS. The risk factor 116b may indicate that an issue is associated with a deployed container. The risk factor 116c may indicate that an issue is associated with a public facing application. For example, the application may have a configured path to the internet. The risk factor 116d may indicate that an issue is associated with a software component loaded in a runtime environment, e.g., a loaded package or software library. For instance, a given software library (e.g., a third-party dependency) within a software component (e.g., image) may be loaded in a runtime environment, where the library includes a vulnerability. Because risk factor 116d applies to the library, the vulnerability may be given higher priority. By introducing the concept of runtime context or properties, an example embodiment can leverage runtime data, which may be acquired via a runtime sensor (e.g., Snyk Runtime Sensor (Snyk Limited, London, UK)), which may use technology such as extended Berkeley Packet Filter (eBPF), a third-party observability service (e.g., the Datadog® platform (Datadog, Inc., New York, NY)), and/or third-party providers such as Dynatrace® (Boston, MA). Other known runtime sensors, technologies, third-party observability services, and third-party providers are also suitable.

In an embodiment, one or more of the example filters 106a-106i may be used in addition to or instead of the example filters 114a-114d. For instance, the filter 106f may be used to select issues having a severity level 104a of C, H, M, and/or L. According to an aspect, a given security product 104k (e.g., Snyk Open Source 126 (Snyk Limited, London, UK)) may classify detected issues as having severity levels 104a of C, H, M, and L, whereas another security product 104k (e.g., Snyk Code (Snyk Limited, London, UK)) may classify detected issues as having severity levels 104a of H, M, and L. Thus, in circumstances where it is desired to view certain issues detected by both such products 104k, the filter 106f may be used to select issues having severity levels 104a of C and H. Alternatively, when it is desired to view certain issues detected by only one product 104k or the other, the filter 106i may be used to select issues according to which product(s) 104k detected the issues.

According to an aspect, the filter 106d may be used to select issues according to an asset classification, which may also be referred to as a business classification. For instance, each application may be assigned a classification of A, B, C, or D, where A indicates highest importance (e.g., applications subject to the Payment Card Industry Data Security Standard (PCI DSS) information security standard) and D indicates lowest importance (e.g., test applications).

In an embodiment, the UI element 108 may be used to add filters based on information about an issue such as exploit maturity 104g (i.e., whether a vulnerability has a known exploit) and data fields associated with the MITRE® Common Vulnerabilities and Exposures (CVE) standard (The MITRE Corporation, Bedford, MA). Other known filters and data fields are also suitable.

According to an embodiment, the filter element 122, which may be a dropdown menu, may allow users to filter issues according to a desired organization.

In an implementation, a name or identifier 104c of a given issue may be a link or clickable element (e.g., 128) that can be selected or activated to provide more information or details about the issue. According to an aspect, a ticket for a given issue 102a-102n may be created in an issue-tracking platform, e.g., Jira® (Atlassian Corporation, Sydney, AU); other known issue-tracking platforms are also suitable.

According to an embodiment, a link or clickable element (e.g., 132) may be provided for a given issue 102a-102n that can be used to display an evidence graph (not shown). An example evidence graph may show information about an issue including a link to an associated source code repository, as well as a trace graph that visualizes each component or element between the repository and an associated front-end environment, such as the particular container, image, and package, etc.

### Example Method Embodiment

FIG. 2 is a flowchart of a method 200 of automatically determining code lineage. The method 200 is computer-implemented and may be implemented using any computing device, e.g., a processor, or combination of computing devices known to those of skill in the art.

The method 200 begins at step 201 by determining at least one component fingerprint associated with a software component. In an embodiment, the software component may include a programming script (e.g., JavaScript, Python, Ruby, etc.), a container image, a cloud workload, a runtime workload, a software library (e.g., JAR, DLL, etc.), a software package, an executable program, and/or other types of software components or artifacts. According to an aspect, the at least one component fingerprint may include a programming script file name, a programming script directory name/path, an object class name, an object class path, an image build command name, a data structure name, a stream name/identifier, and/or link (e.g., URL). At step 202, at least one code fingerprint associated with a codebase is determined. In an implementation, the codebase may include one or more source code repositories (e.g., a version control system (VCS) such as GitHub®, a revision control system (RCS), a source code management (SCM) system, etc.). According to an embodiment, the at least one code fingerprint may include a source code file name and/or a source code directory name/path. In turn, at step 203, correspondence between the determined at least one component fingerprint and the determined at least one code fingerprint is evaluated to determine code lineage of the software component. According to an aspect, evaluating the correspondence may include determining a unique signature or other identifier that is shared by the software component and at least a portion of the codebase and that can be used to associate the software component with the at least a portion of the codebase—where the association is the code lineage. For example, if a codebase includes multiple source code repositories, code lineage may indicate which of the multiple repositories corresponds to a software component. Alternatively, code lineage may indicate which portion of source code within a single repository corresponds to a software component.

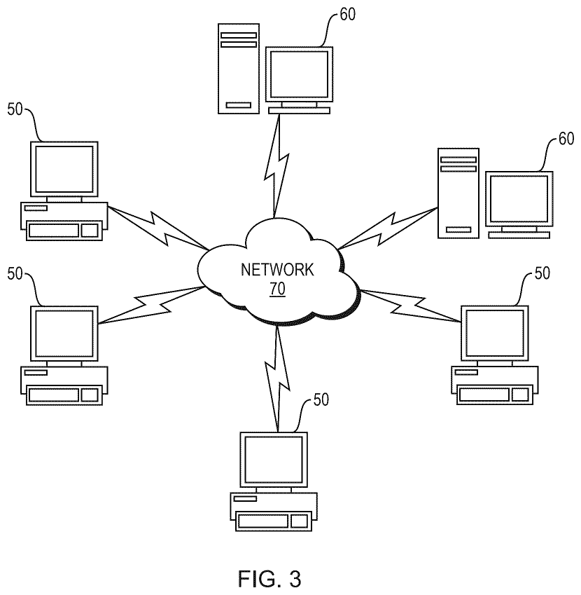

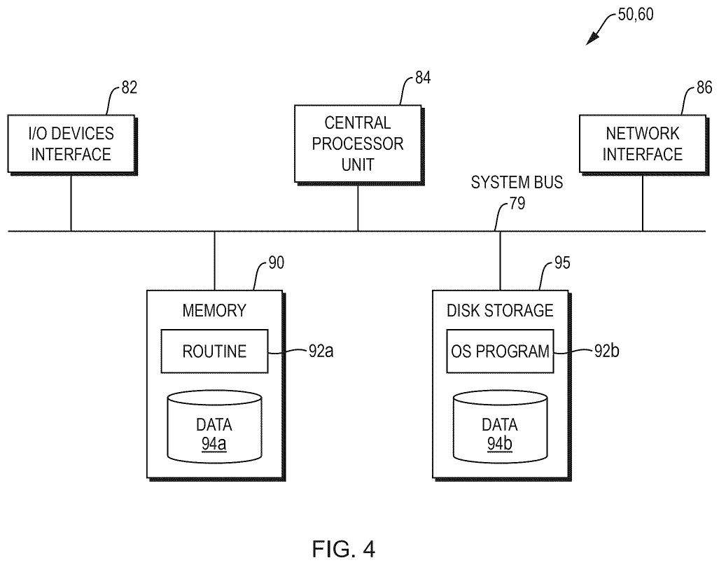

As noted, the method 200 is computer-implemented and, as such, the functionality and effective operations, e.g., the determining (201, 202) and evaluating (203), are automatically implemented by one or more digital processors. The method 200 can also be implemented using any computer device or combination of computing devices known in the art. Among other examples, the method 200 can be implemented using computer(s)/device(s) 50 and/or 60 described hereinbelow in relation to FIGS. 3 and 4.

In an example embodiment of the method 200, the software component may include a file hierarchy. The codebase may include a set of file hierarchies. Determining 201 the at least one component fingerprint may include generating first segment data from the file hierarchy. In an implementation, segment data may include portions of a file hierarchy, such as file and/or directory names. For example, while a complete file hierarchy may be “/io/snyk/test/sample.class,” segments of the hierarchy may include directory names “io,” “snyk,” and “test,” and file name (e.g., not including the file extension) “sample.” The at least one component fingerprint may include the first segment data. Determining 202 the at least one code fingerprint may include generating second segment data from the set of file hierarchies. The at least one code fingerprint may include the second segment data. Evaluating 203 the correspondence between the determined at least one component fingerprint and the determined at least one code fingerprint may include comparing the generated first segment data and the generated second segment data. In one such embodiment, the evaluating 203 may further include: (1) based on a result of comparing the generated first segment data and the generated second segment data, generating a set of candidate file hierarchies from the set of file hierarchies and (2) comparing the file hierarchy and the generated set of candidate file hierarchies to determine the code lineage. According to another such embodiment, the generated first segment data and the generated second segment data may include at least one of: (i) filename data, (ii) directory name data, and (iii) segment frequency data. Further, in yet another such embodiment, comparing the generated first segment data and the generated second segment data may be based on a threshold. According to one such embodiment, the threshold may be 80%.

For example, the first segment data include directory names “io,” “snyk,” “test,” and “first,” and file name “sample” generated from file hierarchy “/io/snyk/test/first/sample.class.” The second segment data may include the following:
a) Directory names “io,” “snyk,” “test,” and “first,” and file name “sample” generated from file hierarchy “/io/snyk/test/first/sample.class”;
b) Directory names “io,” “snyk,” “test,” and “second,” and file name “false” generated from file hierarchy “/io/snyk/test/second/false.class”;
c) Directory names “io,” “snyk,” “test,” and “second,” and file name “sample” generated from file hierarchy “/io/snyk/test/second/sample.class”; and
d) Directory names “com,” “doberman,” and “guard,” and file name “Patch” generated from file hierarchy “/com/doberman/guard/Patch.class.”

According to an aspect, the generated set of candidate file hierarchies may include the example hierarchies (a), (b), and (c) above because at least some of the second segment data corresponding to the hierarchies (a), (b), and (c) matches the example first segment data. However, hierarchy (d) may not be included in the set of candidates because none of its corresponding second segment data matches the example first segment data. If a threshold, e.g., 80%, is further applied when comparing the first and second segment data, then hierarchy (b) may also be excluded from the set of candidates because only 60% of its segments (i.e., “io,” “snyk,” and “test”) match the example first segment data, whereas the segments for hierarchies (a) (i.e., “io,” “snyk,” “test,” “first,” and “sample”) and (c) (i.e., “io,” “snyk,” “test,” and “sample”) match by at least 80%.

In an implementation, information relating to the file hierarchy, the set of file hierarchies, the first segment data, and/or the second segment data may be stored in database tables such as the example image_evidence and source_code_evidence tables described hereinabove.

According to an example embodiment of the method 200, the software component may include a container image. Determining 201 the at least one component fingerprint may include extracting at least one container image layer from the container image. The at least one component fingerprint may include the at least one container image layer. Determining 202 the at least one code fingerprint may include extracting at least one build command from the codebase. The at least one code fingerprint may include the at least one build command. Evaluating 203 the correspondence between the determined at least one component fingerprint and the determined at least one code fingerprint may include comparing the extracted at least one container image layer and the extracted at least one build command to determine the code lineage. In one such embodiment, the method 200 may further include normalizing the extracted at least one container image layer. According to an aspect, extracting the at least one container image layer may include obtaining or extracting a “history” metadata object or item for the container image, e.g., from a container image registry, that includes information about layers used to build the image. In an implementation, comparing the extracted at least one container image layer and the extracted at least one build command may include determining which build command(s) in the codebase were used to create the layers from which the container image was constructed. This provides a code lineage for the container image by associating the image with particular build command(s) within the codebase. In an embodiment, the extracted at least one build command is processed to determine container image layer(s) that result from the at least one build command. The evaluating 203 in such an embodiment compares (i) the determined container layer(s) that result from the at least one build command to (ii) the extracted at least one container image layer. This comparison looks for matching between (i) and (ii) to determine the code lineage.

In an example embodiment of the method 200, the software component may include multiple software components. The method 200 may further include: (1) selecting a given software component of the multiple software components based on the determined code lineage and at least one runtime property of the given software component and (2) analyzing the selected software component. According to one such embodiment, a given runtime property of the at least one runtime property may indicate that the selected software component is deployed to a production environment, not in use, deployed to a secure environment, publicly accessible, or loaded in an execution environment. For instance, as described hereinabove with respect to FIG. 1, the filter 114d may be used to select software component(s) with runtime properties of being deployed 116b to a production environment, publicly accessible 116c, and loaded 116d in an execution environment. In an implementation, analyzing the selected software component(s) may include extracting file hierarchies and/or build scripts (e.g., Dockerfiles).

According to an example embodiment of the method 200, the codebase may include multiple errors. The method 200 may further include: (1) selecting a given error of the multiple errors based on the determined code lineage and (2) rectifying the selected given error. According to an aspect, selecting the given error may including selecting one or more issues 102a-102n (FIG. 1) where the determined code lineage indicates an association between the corresponding asset 104e (FIG. 1) and source code 104f (FIG. 1). In an implementation, rectifying the selected given error may include resolving or addressing the selected one or more issues 102a-102n.

In an example embodiment of the method 200, the codebase may include multiple code repositories. The determined code lineage may indicate correspondence between the software component and a code repository of the multiple code repositories.

### Computer Support

FIG. 3 is a schematic view of a computer network in which embodiments may be implemented. Client computer(s)/devices 50 and server computer(s) 60 provide processing, storage, and input/output (I/O) devices executing application programs and the like. Client computer(s)/device(s) 50 can also be linked through communications network 70 to other computing devices, including other client device(s)/processor(s) 50 and server computer(s) 60. The communications network 70 can be part of a remote access network, a global network (e.g., the Internet), cloud computing servers or service, a worldwide collection of computers, local area or wide area networks, and gateways that currently use respective protocols (e.g., TCP/IP, Bluetooth®, etc.) to communicate with one another. Other electronic device/computer network architectures are also suitable.

FIG. 4 is a block diagram illustrating an example embodiment of a computer node (e.g., client processor(s)/device(s) 50 or server computer(s) 60) in the computer network 70 of FIG. 3. Each computer node 50, 60 contains system bus 79, where a bus is a set of hardware lines used for data transfer among components of a computer or processing system. The system bus 79 is essentially a shared conduit that connects different elements of a computer system (e.g., processor, disk storage, memory, I/O ports, network ports, etc.) that enables transfer of information between the elements. Attached to the system bus 79 is an I/O devices interface 82 for connecting various input and output devices (e.g., keyboard, mouse, display(s), printer(s), speaker(s), etc.) to the computer node 50, 60. A network interface 86 allows the computer node to connect to various other devices attached to a network (e.g., the network 70 of FIG. 3). A memory 90 provides volatile storage for computer software instructions 92a and data 94a used to implement embodiments of the present disclosure (e.g., the user interface 100 of FIG. 1, the method 200 of FIG. 2, etc.). A disk storage 95 provides non-volatile storage for the computer software instructions 92b and data 94b used to implement an embodiment of the present disclosure. A central processor unit 84 is also attached to the system bus 79 and provides for execution of computer instructions.

In an embodiment, the processor routines 92a-92b and data 94a-94b are a computer program product (generally referenced as 92), including a non-transitory, computer readable medium (e.g., a removable storage medium such as DVD-ROM(s), CD-ROM(s), diskette(s), tape(s), etc.) that provides at least a portion of the software instructions for the disclosure system. The computer program product 92 can be installed by any suitable software installation procedure, as is well known in the art. In another embodiment, at least a portion of the software instructions may also be downloaded over a cable, communication, and/or wireless connection. In other embodiments, the disclosure programs are a computer program propagated signal product embodied on a propagated signal on a propagation medium (e.g., a radio wave, an infrared wave, a laser wave, a sound wave, or an electrical wave propagated over a global network such as the Internet, or other network(s)). Such carrier medium or signals provide at least a portion of the software instructions for the present disclosure routines/program 92.

In alternative embodiments, the propagated signal is an analog carrier wave or digital signal carried on the propagated medium. For example, the propagated signal may be a digitized signal propagated over a global network (e.g., the Internet), a telecommunications network, or other networks (such as the network 70 of FIG. 3). In one embodiment, the propagated signal is a signal that is transmitted over the propagation medium over a period of time, such as the instructions for a software application sent in packets over a network over a period of milliseconds, seconds, minutes, or longer. In another embodiment, the computer readable medium of the computer program product 92 is a propagation medium that the computer system 50 may receive and read, such as by receiving the propagation medium and identifying a propagated signal embodied in the propagation medium, as described above for computer program propagated signal product.

Generally speaking, the term “carrier medium” or transient carrier encompasses the foregoing transient signals, propagated signals, propagated medium, storage medium, and the like.

In other embodiments, the program product 92 may be implemented as a so-called Software as a Service (SaaS), or other installation or communication supporting end-users.

Embodiments can be implemented in existing tools and platforms. For instance, embodiments can be implemented using features and functionalities of Snyk AppRisk, Snyk Code, Snyk Open Source, Snyk Container, Snyk Infrastructure as Code (IaC), and other tools and platforms by Applicant-Assignee Snyk Limited, among other examples.

Embodiments or aspects thereof may be implemented in the form of hardware including but not limited to hardware circuitry, firmware, or software. If implemented in software, the software may be stored on any non-transient computer readable medium that is configured to enable a processor to load the software or subsets of instructions thereof. The processor then executes the instructions and is configured to operate or cause an apparatus to operate in a manner as described herein.

Further, hardware, firmware, software, routines, or instructions may be described herein as performing certain actions and/or functions of the data processors. However, it should be appreciated that such descriptions contained herein are merely for convenience and that such actions in fact result from computing devices, processors, controllers, or other devices executing the firmware, software, routines, instructions, etc.

It should be understood that the flow diagrams, block diagrams, and network diagrams may include more or fewer elements, be arranged differently, or be represented differently. But it further should be understood that certain implementations may dictate the block and network diagrams and the number of block and network diagrams illustrating the execution of the embodiments be implemented in a particular way.

Accordingly, further embodiments may also be implemented in a variety of computer architectures, physical, virtual, cloud computers, and/or some combination thereof, and, thus, the data processors described herein are intended for purposes of illustration only and not as a limitation of the embodiments.

For example, the foregoing description and details of embodiments reference Applicant-Assignee (Snyk Limited) tools and platforms, for purposes of illustration and not limitation. Other similar tools and platforms are suitable.

The teachings of all patents, published applications, and references cited herein are incorporated by reference in their entirety.

While example embodiments have been particularly shown and described, it will be understood by those skilled in the art that various changes in form and details may be made therein without departing from the scope of the embodiments encompassed by the appended claims.

What is claimed is:

1. A computer-implemented method of automatically determining code lineage, the method comprising:
determining at least one component fingerprint associated with a software component;
determining at least one code fingerprint associated with a codebase; and
evaluating correspondence between the determined at least one component fingerprint and the determined at least one code fingerprint to determine code lineage of the software component.

2. The method of claim 1, wherein:
the software component includes a file hierarchy;
the codebase includes a set of file hierarchies;
determining the at least one component fingerprint includes generating first segment data from the file hierarchy, the at least one component fingerprint including the first segment data;
determining the at least one code fingerprint includes generating second segment data from the set of file hierarchies, the at least one code fingerprint including the second segment data; and
evaluating the correspondence between the determined at least one component fingerprint and the determined at least one code fingerprint includes comparing the generated first segment data and the generated second segment data.

3. The method of claim 2, wherein the evaluating further includes:
based on a result of comparing the generated first segment data and the generated second segment data, generating a set of candidate file hierarchies from the set of file hierarchies; and
comparing the file hierarchy and the generated set of candidate file hierarchies to determine the code lineage.

4. The method of claim 2, wherein the generated first segment data and the generated second segment data include at least one of: (i) filename data and (ii) directory name data.

5. The method of claim 2, wherein comparing the generated first segment data and the generated second segment data is based on a threshold.

6. The method of claim 5, wherein the threshold is 80%.

7. The method of claim 1, wherein:
the software component includes a container image;
determining the at least one component fingerprint includes extracting at least one container image layer from the container image, the at least one component fingerprint including the at least one container image layer;
determining the at least one code fingerprint includes extracting at least one build command from the codebase, the at least one code fingerprint including the at least one build command; and
evaluating the correspondence between the determined at least one component fingerprint and the determined at least one code fingerprint includes comparing the extracted at least one container image layer and the extracted at least one build command to determine the code lineage.

8. The method of claim 7, further comprising:
normalizing the extracted at least one container image layer.

9. The method of claim 1, wherein the software component includes multiple software components, and further comprising:
selecting a given software component of the multiple software components based on the determined code lineage and at least one runtime property of the given software component; and
analyzing the selected software component.

10. The method of claim 9, wherein a given runtime property of the at least one runtime property indicates that the selected software component is: deployed to a production environment, not in use, deployed to a secure environment, publicly accessible, or loaded in an execution environment.

11. The method of claim 1, wherein the codebase includes multiple errors, and further comprising:
selecting a given error of the multiple errors based on the determined code lineage; and
rectifying the selected given error.

12. The method of claim 1, wherein the codebase includes multiple code repositories, and wherein the determined code lineage indicates correspondence between the software component and a code repository of the multiple code repositories.

13. A computer-based system for automatically determining code lineage, the computer-based system comprising:
a processor; and
a memory with computer code instructions stored thereon, the processor and the memory, with the computer code instructions, being configured to cause the system to:
determine at least one component fingerprint associated with a software component;
determine at least one code fingerprint associated with a codebase; and
evaluate correspondence between the determined at least one component fingerprint and the determined at least one code fingerprint to determine code lineage of the software component.

14. The system of claim 13:
wherein the software component includes a file hierarchy;
wherein the codebase includes a set of file hierarchies;
where, in determining the at least one component fingerprint, the processor and the memory, with the computer code instructions, are configured to cause the system to generate first segment data from the file hierarchy, the at least one component fingerprint including the first segment data;
where, in determining the at least one code fingerprint, the processor and the memory, with the computer code instructions, are configured to cause the system to generate second segment data from the set of file hierarchies, the at least one code fingerprint including the second segment data; and
where, in evaluating the correspondence, the processor and the memory, with the computer code instructions, are configured to cause the system to perform a comparison of the generated first segment data and the generated second segment data.

15. The system of claim 14, where, in evaluating the correspondence, the processor and the memory, with the computer code instructions, are further configured to cause the system to:
based on a result of the comparison, generate a set of candidate file hierarchies from the set of file hierarchies; and
compare the file hierarchy and the generated set of candidate file hierarchies to determine the code lineage.

16. The system of claim 14, wherein the generated first segment data and the generated second segment data include at least one of: (i) filename data and (ii) directory name data.

17. The system of claim 13:
wherein the software component includes a container image;
where, in determining the at least one component fingerprint, the processor and the memory, with the computer code instructions, are configured to cause the system to extract at least one container image layer from the container image, the at least one component fingerprint including the at least one container image layer;
where, in determining the at least one code fingerprint, the processor and the memory, with the computer code instructions, are configured to cause the system to extract at least one build command from the codebase, the at least one code fingerprint including the at least one build command; and
where, in evaluating the correspondence, the processor and the memory, with the computer code instructions, are configured to cause the system to compare the extracted at least one container image layer and the extracted at least one build command to determine the code lineage.

18. The system of claim 13, wherein the software component includes multiple software components, and wherein the processor and the memory, with the computer code instructions, are further configured to cause the system to:
select a given software component of the multiple software components based on the determined code lineage and at least one runtime property of the given software component; and
analyze the selected software component.

19. The system of claim 13, wherein the codebase includes multiple errors, and wherein the processor and the memory, with the computer code instructions, are further configured to cause the system to:
select a given error of the multiple errors based on the determined code lineage; and
rectify the selected given error.

20. A computer program product for automatically determining code lineage, the computer program product comprising a non-transitory computer-readable medium with computer code instructions stored thereon, the computer code instructions being configured, when executed by a processor, to cause an apparatus associated with the processor to:
determine at least one component fingerprint associated with a software component;
determine at least one code fingerprint associated with a codebase; and
evaluate correspondence between the determined at least one component fingerprint and the determined at least one code fingerprint to determine code lineage of the software component.
